(19) United States
(12) Patent Application Publication
(10) Pub. No.: US 2025/0093837 A1
(43) Pub. Date: Mar. 20, 2025

(54) NUMERICAL CONTROL DEVICE

(71) Applicant: FANUC CORPORATION, Yamanashi (JP)

(72) Inventor: Kenji KAIHARA, Yamanashi (JP)

(73) Assignee: FANUC CORPORATION, Yamanashi (JP)

(21) Appl. No.: 18/729,330

(22) PCT Filed: Mar. 15, 2022
(86) PCT No.: PCT/JP2022/011745

§ 371 Date: Jul. 16, 2024

(51) Int. Cl. G05B 19/18; G05B 19/4155

(52) U.S. Cl. CPC G05B 19/182; G05B 19/4155; G05B 2219/37602; G05B 2219/45129; G05B 2219/49108; G05B 2219/49397

(57) ABSTRACT

Provided is a numerical control device that eliminates the need for rapid acceleration/deceleration of a cutting tool during boring and that is capable of minimizing vibration of a machine tool. This numerical control device comprises: a deep hole boring execution unit which performs deep hole boring by repeating a cutting operation for making a cut in a workpiece while rotating the cutting tool and a cutting halting operation for halting the cutting operation of the workpiece while rotating the cutting tool; and a chip-discharging time calculation unit which calculates a chip discharging time depending on the position of the cutting tool after each cut during the cutting operation. The deep hole boring execution unit performs the cutting halting operation during the chip-discharging time.

### TECHNICAL FIELD

The present invention relates to a numerical control device.

### BACKGROUND ART

Conventionally, drilling has been performed by a machining method in which a canned cycle function is used (for example, see Patent Document 1). In particular, continuous drilling is generally performed using the canned cycle function. A machining program for drilling a hole at a specified position is developed by instructing an argument necessary for a canned cycle.

The accuracy of drilling ranges widely from low accuracy to high accuracy, and low vibration and high-speed machining are required in drilling at any level of accuracy. In particular, in deep hole drilling, a canned cycle (peck cycle) in which drilling is carried out while repeatedly performing cutting and retraction is commonly employed in order to prevent chip clogging. A retraction amount for a cutting tool 21 can be arbitrarily designated by a command value of the canned cycle. The retraction amount needs to be instructed in consideration of an amount of chips to be removed. The value of a cutting amount and the value of a retraction amount from a point R to a hole bottom are each constant from the start of drilling.

### CITATION LIST

### Patent Document

Patent Document 1: Japanese Unexamined Patent Application, Publication No. 2020-086475

### DISCLOSURE OF THE INVENTION

### Problems to be Solved by the Invention

According to the known art, since the retraction operation following the cutting is performed at a rapid traverse speed during the canned cycle, the cutting tool is significantly accelerated and decelerated, thereby causing vibration in the machine tool. In particular, in deep hole drilling, which is performed using a long drill having a long cutting edge in many cases, vibration in the machine tool makes the cutting tool vibrate, whereby the cutting tool is worn faster.

In a case where a small retraction amount is instructed and a command value indicates a large depth, vibration in the machine tool prevents the cutting tool from performing vertical cutting. Under the above-described circumstances, there is a demand for a numerical control device that eliminates the need for sudden acceleration/deceleration of a cutting tool and is capable of preventing or reducing vibration in a machine tool. Means for Solving the Problems

An aspect of the present disclosure is directed to a numerical control device including: a deep-hole drilling execution unit configured to carry out deep hole drilling by repeatedly performing a cutting operation of causing a cutting tool to cut into a workpiece while rotating the cutting tool and a cutting stop operation of stopping the cutting tool from cutting into the workpiece while rotating the cutting tool; and a chip removal time calculation unit configured to calculate a chip removal time in accordance with a position of the cutting tool at an end of each cutting in the cutting operation. The deep-hole drilling execution unit performs the cutting stop operation for the chip removal time.

### Effects of the Invention

The present invention eliminates the need for sudden acceleration/deceleration of a cutting tool during drilling, and makes it possible to prevent or reduce vibration in a machine tool.

### BRIEF DESCRIPTION OF THE DRAWINGS

FIG. 1 is a block diagram illustrating a configuration of a numerical control device according to an embodiment;

FIG. 2 is a diagram illustrating an example of deep hole drilling by a machine tool using a conventional canned cycle function;

FIG. 3 is a diagram illustrating an example of deep hole drilling according to the embodiment;

FIG. 4 is a diagram illustrating a helix angle and a tool length per rotation of a cutting tool according to the embodiment;

FIG. 5 is a diagram illustrating a cutting tool for use in calculation of a chip removal time when a helix angle is 30°; and

FIG. 6 is a diagram illustrating an outline of another example of deep hole drilling according to the present embodiment.

### PREFERRED MODE FOR CARRYING OUT THE INVENTION

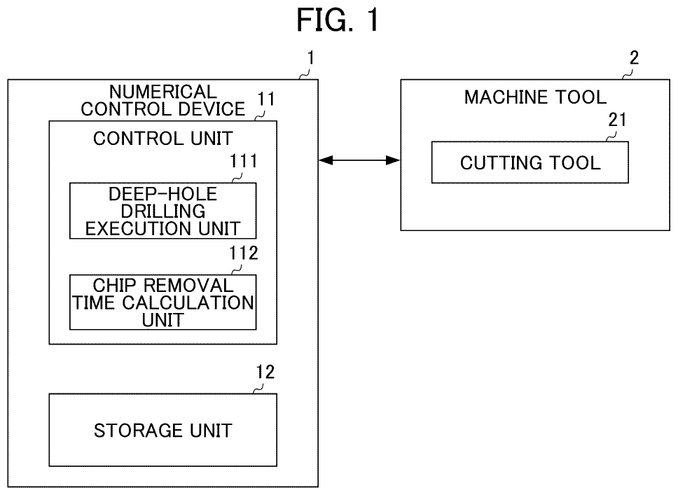

An example of embodiments of the present invention will be described below. FIG. 1 is a diagram illustrating a configuration of a numerical control device 1 and a machine tool 2 according to the present embodiment.

The numerical control device 1 controls and causes the machine tool 2 to perform predetermined machining. The numerical control device 1 includes a control unit 11 and a storage unit 12. The control unit 11 is a processor such as a central processing unit (CPU), and functions as a deep-hole drilling execution unit 111 and a chip removal time calculation unit 112 by executing programs stored in the storage unit 12.

The storage unit 12 includes storage devices such as a read only memory (ROM) that stores an operating system (OS), application programs, etc., a random access memory (RAM), and a hard disk drive or a solid state drive (SSD) that stores various kinds of information.

The machine tool 2 performs predetermined machining such as drilling, measurement of a tool, and the like under the control of the numerical control device 1. Specifically, in the present embodiment, the machine tool 2 includes a cutting tool 21 and is configured to perform drilling.

The machine tool 2 includes a servo motor that is driven to machine a workpiece, a main shaft and a feed shaft mounted to the servo motor, jigs and cutting tools corresponding to the respective shafts, a table on which the workpiece is fastened, etc. The machine tool 2 drives the servo motor based on an operation command outputted from the numerical control device 1 to rotate and move the cutting tool 21, thereby performing drilling. More specifically, the machine tool 2 performs deep hole drilling using the cutting tool 21. Here, in general, deep hole drilling refers to drilling a hole the depth of which is 4 times or more the diameter of the hole.

The numerical control device 1 controls and causes the machine tool 2 to carry out the deep hole drilling by executing a machining program for the deep hole drilling. The machining program includes, for example, a G code for the machine tool to perform the deep hole drilling, and argument codes each composed of a respective alphabetical character and defining a drilling condition.

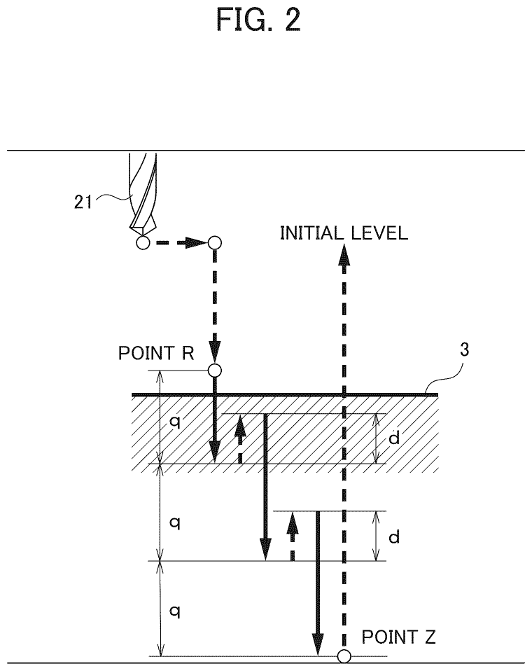

FIG. 2 is a diagram illustrating an example of the deep hole drilling carried out by the machine tool 2 using a conventional canned cycle function. In the case of this general deep hole drilling, the machine tool 2 first performs rapid traverse so as to move the cutting tool 21 to a reference point (hereinafter, referred to as the point R) that is a drilling start position.

Next, the machine tool 2 moves the cutting tool 21 at a cutting feed rate while rotating the cutting tool 21 to thereby cut a cutting amount q from the point R. Next, the machine tool 2 retracts the cutting tool 21 by a retraction amount d.

In this way, the machine tool 2 drills a deep hole from the point R to a hole bottom Z while repeating the cutting and the retraction. In particular, in deep hole drilling, a canned cycle (peck cycle) in which drilling is carried out while repeatedly performing cutting and retraction is commonly employed in order to prevent chip clogging. The retraction amount for the cutting tool 21 can be arbitrarily designated by a command value of the canned cycle. The retraction amount needs to be instructed in consideration of an amount of chips to be removed. The value of the cutting amount and the value of the retraction amount from the point R to the hole bottom are each constant from the start of drilling.

Note that, in the present specification, for convenience of description, the cutting operation and the retraction operation that are performed a plurality of times are illustrated as if the operations were performed at different X positions and different Y positions; however, the operations are actually performed at the same X position and the same Y position.

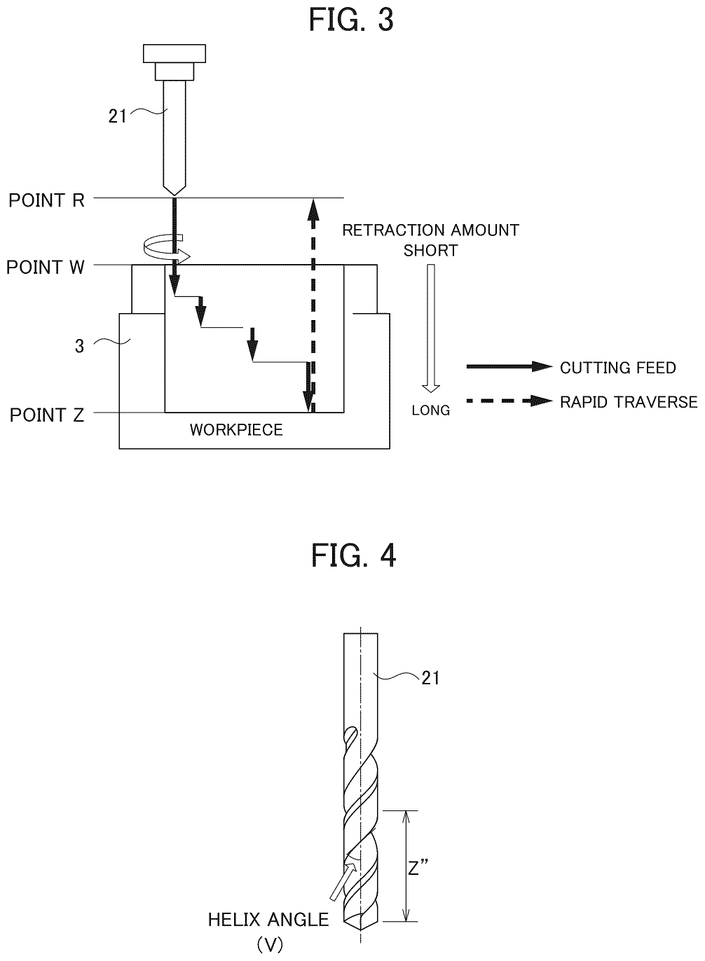

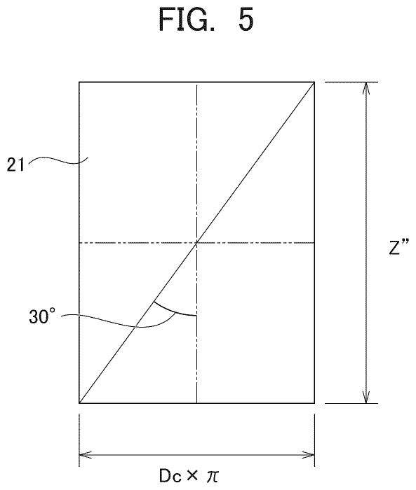

FIG. 3 is a diagram illustrating an example of deep hole drilling according to the present embodiment. FIG. 4 is a diagram illustrating a helix angle V and a tool length Z″ per rotation of the cutting tool 21 according to the present embodiment. FIG. 5 is a diagram illustrating the cutting tool 21 for use in calculation of a chip removal time when the helix angle V is 30°. In FIG. 3, the point W indicates a reference point on a surface of a workpiece 3, and the point Z indicates the position (depth) of the bottom of a deep hole.

The deep-hole drilling execution unit 111 carries out deep hole drilling by repeatedly performing a cutting operation of causing the cutting tool 21 to cut into the workpiece 3 while rotating the cutting tool 21 and a cutting stop operation (i.e., a dwell operation) of stopping the cutting tool 21 from cutting into the workpiece 3 while rotating the cutting tool 21.

The chip removal time calculation unit 112 calculates a chip removal time in accordance with a position of the cutting tool 21 at the end of each cutting in the cutting operation. The deep-hole drilling execution unit 111 performs the cutting stop operation for the calculated chip removal time.

The dwell function refers to causing a delay of an instructed time period before proceeding to the operation of a next block. In response to a dwell instructed during the canned cycle, the cutting edge tip of the cutting tool 21 is made to stay at the hole bottom for the instructed time period upon reaching the hole bottom. During the dwell, the rotation, etc. of the main shaft is not stopped. The dwell function is mainly used in machining for forming a groove and drilling a hole in order to prevent insufficient shaving of a bottom surface and improve accuracy.

A chip generated during deep hole drilling becomes thinner in the cutting stop operation than at a standard feed rate, and the thinner portion of the chip generated in the cutting stop operation may be broken off from the other portion generated at the standard feed rate. This phenomenon has a considerable dependence on a material, a rake angle (helix angle) of the tool, and a friction coefficient. This dependence can be expressed by a chip breaking-off capability coefficient Kc , which is determined based on experimental values. There are workpieces made of different materials such as cast iron, aluminum, etc. A chip of cast iron is easy to break off, whereas a chip of aluminum has ductility. Accordingly, there is a case where a portion of a chip is not completely broken off from the other portion. Moreover, chips having a certain length cannot be removed during a second cutting operation. To address this, the chip breaking-off capability coefficient Kc is used to optimize the chip removal time T.

Specifically, the chip removal time calculation unit 112 calculates the chip removal time T based on the rotation speed S, the number of cutting edges B, the radius D_{c}, and the helix angle V of the cutting tool 21, the position Zq of the cutting tool 21 at the end of each cutting in the cutting operation, and the chip breaking-off capability coefficient Kc. The deep-hole drilling execution unit 111 performs the cutting stop operation for the chip removal time T.

Here, the chip removal time T is calculated according to Equations (1), (2), (3), and (4) described below.

Time T″ per rotation=1/S×60 (1)

Time T1 until breaking-off of a chip from the end of cutting=1/S×60×1/B (2)

Tool length Z″ per rotation at helix angle V=D_{c}×π/tan V (3)

Chip removal time T=(Zq/Z″×T″×Kc)+T1 (4)

The rotation speed S in the above equations is obtained by referring to a value instructed prior to a canned cycle command. The helix angle V and the tool length Z″ are defined as illustrated in FIG. 4.

Referring to FIG. 5, according to Equation (2), when the helix angle V is 30°, the following equations apply: tan 30°=D_{c}×π/Z″ and Z″=D_{c}×π/tan 30°. The tool length Z″ per rotation at the helix angle V corresponds to the moving distance of chips when the chips are rotated 360 degrees along a groove on the cutting tool 21 from the cutting edge tip.

To perform the deep hole drilling described above, the machining program is described as follows, for example. G73.1 X ** Y ** Z ** B ** R ** Q ** F ** K ** V **, D999

Here, G73.1 is an example of G codes for performing deep hole drilling, the argument commands X and Y indicate positioning of the cutting tool 21, the argument Z indicates a command value, the argument R indicates the point R, the argument Q indicates a cutting amount, the argument F indicates a cutting feed rate, the argument K indicates a repetition operation, the argument V indicates the helix angle of the drill of the cutting tool 21, and the argument D999 indicates an optimization mode in which the cutting stop operation is performed for the above-described chip removal time T.

In this way, the cutting stop operation is performed for the chip removal time T during which the chips are removed from the hole. That is, the cutting stop operation (i.e., the dwell operation) is performed in place of the retraction operation that follows the cutting in the known art, thereby eliminating the need for suddenly accelerating and decelerating the cutting tool 21 in the retraction operation, and making it possible to prevent or reduce vibration in the machine tool 2.

There may be a case where a parameter is absent from the canned cycle command. For example, when the command indicating the helix angle V is absent from the argument commands of the machining program for the deep hole drilling, the chip removal time calculation unit 112 adopts a predetermined helix angle V to calculate the chip removal time T. For example, when the command indicating the helix angle V is absent, the chip removal time calculation unit 112 adopts 30°, which is a typical helix angle of general-purpose drills.

The radius D_{c} of the cutting tool 21 and the chip breaking-off capability coefficient Kc may not be instructed as the arguments of the machining program, but may be obtained by referring to data registered in the machine tool 2. The rotation speed S of cutting tool 21 may be obtained by referring to a command value provided prior to the canned cycle command. Thus, the numerical control device 1 can suitably carry out the deep hole drilling even when a parameter is absent from the canned cycle command.

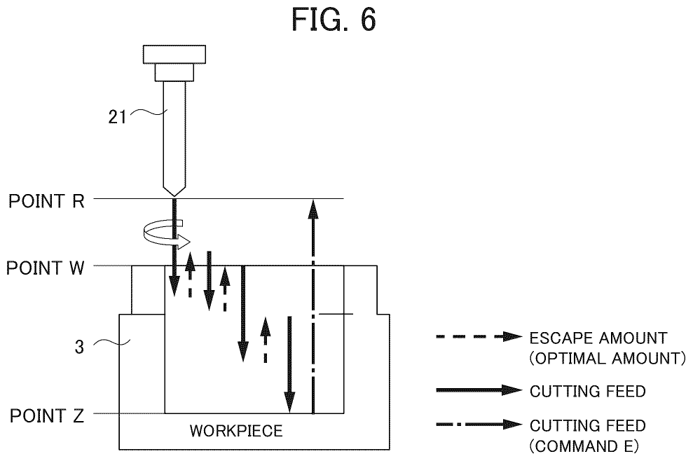

FIG. 6 is a diagram illustrating an outline of another example of the deep hole drilling according to the present embodiment. In a case where an argument P that instructs a dwell is included in the argument commands of a machining program for the deep hole drilling, the deep-hole drilling execution unit 111 causes the cutting tool 21 to pause for the time instructed by the argument P, while making the cutting tool 21 continue rotating, with respect to the bottom of a hole for which cutting required to reach a command value designated in the machining program has all been completed. In this way, the numerical control device 1 can perform the dwell according to the command value of the canned cycle at the time of completion of the deep hole drilling, in order to improve the quality of the hole bottom.

Furthermore, in a case where an argument E that instructs a return speed is included in the argument commands of the machining program for the deep hole drilling, the deep-hole drilling execution unit 111 moves the cutting tool 21 at the return speed instructed by the argument E. In a case where the argument E is not included in the argument commands of the machining program, the deep-hole drilling execution unit 111 moves the cutting tool 21 at a rapid traverse speed. Thus, the numerical control device 1 can instruct the return speed for returning following the end of the machining, by means of the argument.

The machining program is described as follows, for example. G73.1 X ** Y ** Z ** B ** R ** Q ** F ** K ** V **, D999 E ** P **

Here, the argument P indicates the dwell (retraction from hole bottom), and the argument E indicates the return speed for returning following the end of the machining.

The deep-hole drilling execution unit 111 may change the cutting amount for each step of the canned cycle. In this way, the numerical control device 1 can reduce the number of steps when a workpiece that is easy to cut is machined.

The deep-hole drilling execution unit 111 may change the feed rate for each step of the canned cycle. In this way, the numerical control device 1 can be more versatile than the known art. For example, the feed rate is increased in a range where the cutting is performed at a shallow position, and is reduced in a range where the cutting is performed at a deep position. For example, the numerical control device 1 reduces the feed rate when the cutting tool 21 starts cutting into the workpiece 3, whereby curving of the shape of the drilled deep hole can be reduced or prevented.

As described above, according to the present embodiment, the numerical control device 1 includes the deep-hole drilling execution unit 111 that carries out deep hole drilling while repeatedly performing the cutting operation of causing the cutting tool 21 to cut into the workpiece 3 while rotating the cutting tool 21 and the cutting stop operation of stopping the cutting tool 21 from cutting into the workpiece 3 while rotating the cutting tool 21, and the chip removal time calculation unit 112 that calculates the chip removal time T in accordance with the position of the cutting tool 21 at the end of each cutting in the cutting operation. The deep-hole drilling execution unit 111 performs the cutting stop operation for the chip removal time T.

Thus, the numerical control device 1 performs the cutting stop operation for the chip removal time T during which chips are removed from the hole. The numerical control device 1 performs the cutting stop operation (i.e., the dwell operation) in place of the retraction operation that follows the cutting in the known art, thereby eliminating the need for suddenly accelerating and decelerating the cutting tool 21 in the retraction operation, and making it possible to prevent or reduce vibration in the machine tool 2.

The chip removal time calculation unit 112 calculates the chip removal time T based on the rotation speed S, the number of cutting edges B, the radius D_{c}, and the helix angle V of the cutting tool 21, the position Zq of the cutting tool 21 at the end of each cutting in the cutting operation, and the chip breaking-off capability coefficient Kc. The deep-hole drilling execution unit 111 performs the cutting stop operation for the chip removal time T. Due to this feature, the numerical control device 1 performs the cutting stop operation for the chip removal time T during which the chips are removed from the hole, thereby making it possible to promote efficient and appropriate removal of the chips from the hole.

In a case where a command indicating the helix angle V is absent from the argument commands of the machining program for the deep hole drilling, the chip removal time calculation unit 112 adopts a predetermined helix angle to calculate the chip removal time T. Due to this feature, the numerical control device 1 can efficiently perform the deep hole drilling even when a certain parameter is absent from the commands of the canned cycle.

In a case where the argument commands of the machining program for the deep hole drilling include the argument P that instructs a dwell, the deep-hole drilling execution unit 111 performs a pause operation for the time instructed by the argument P while making the cutting tool 21 continue rotating, with respect to the bottom of the hole for which cutting required to reach a command value designated in the machining program has all been completed. Due to this feature, the numerical control device 1 can perform the dwell according to the command value of the canned cycle at the time of completion of the deep hole drilling, in order to improve the quality of the hole bottom.

In a case where an argument E that instructs a return speed is included in the argument commands of the machining program for the deep hole drilling, the deep-hole drilling execution unit 111 moves the cutting tool 21 at the return speed instructed by the argument E. Due to this feature, the numerical control device 1 can instruct the return speed for returning following the end of the machining by means of the argument, and can further improve the efficiency of deep hole drilling.

The numerical control device 1 of the embodiment described above can be implemented by hardware, software, or a combination thereof. The control method performed by the numerical control device 1 can also be implemented by hardware, software, or a combination thereof. Here, the implementation by software means that a computer reads and executes a program for the implementation.

The program can be stored in various types of non-transitory computer readable media and can be provided to a computer. The non-transitory computer readable media include various types of tangible storage media. Examples of the non-transitory computer readable media include a magnetic recording medium (e.g., a hard disk drive), a magnetic-optical recording medium (e.g., a magnetic optical disk), a read only memory (CD-ROM), a CD-R, a CD-R/W, and a semiconductor memory (e.g., a mask ROM, a programmable ROM (PROM), an erasable PROM (EPROM), a flash ROM, and a random access memory (RAM)).

Although the above-described embodiments are preferred embodiments of the present invention, the scope of the present invention is not limited only to the above-described embodiments, and various modifications can be made without departing from the spirit of the present invention.

### EXPLANATION OF REFERENCE NUMERALS

1: Numerical control device
2: Machine tool
3: Workpiece
21: Cutting tool
11: Control Unit
12: Storage unit
111: Deep-hole drilling execution unit
112: Chip removal time calculation unit

1. A numerical control device comprising:
a deep-hole drilling execution unit configured to carry out deep hole drilling by repeatedly performing a cutting operation of causing a cutting tool to cut into a workpiece while rotating the cutting tool and a cutting stop operation of stopping the cutting tool from cutting into the workpiece while rotating the cutting tool; and
a chip removal time calculation unit configured to calculate a chip removal time in accordance with a position of the cutting tool at an end of each cutting in the cutting operation,
wherein the deep-hole drilling execution unit performs the cutting stop operation for the chip removal time.

2. The numerical control device according to claim 1, wherein
the chip removal time calculation unit calculates the chip removal time based on a rotation speed, a number of cutting edges, a radius, and a helix angle of the cutting tool, the position of the cutting tool at the end of each cutting in the cutting operation, and a chip breaking-off capability coefficient, and
the deep-hole drilling execution unit performs the cutting stop operation for the chip removal time.

3. The numerical control device according to claim 2, wherein in a case where a command indicating the helix angle is absent from argument commands of a machining program for the deep hole drilling, the chip removal time calculation unit adopts a predetermined helix angle to calculate the chip removal time.

4. The numerical control device according to claim 2, wherein in a case where a command of an argument P is included in argument commands of a machining program for the deep hole drilling, the deep-hole drilling execution unit performs a pause operation for a time instructed by the argument, while making the cutting tool continue rotating, with respect to a bottom of a hole for which cutting required to reach a command value designated in the machining program has all been completed.

5. The numerical control device according to claim 2, wherein in a case where an argument command that instructs a return speed is included in argument commands of a machining program for the deep hole drilling, the deep-hole drilling execution unit moves the cutting tool at the return speed instructed by the argument command.
